(19) United States
(12) Patent Application Publication
(10) Pub. No.: US 2026/0219028 A1
(43) Pub. Date: Jul. 30, 2026

(54) METHOD AND APPARATUS FOR ALL-OPTICAL SPATIAL FREQUENCY DOMAIN SCANNING FOR BROADBAND HIGH-PRECISION MEASUREMENT

(71) Applicant: Electronics and Telecommunications Research Institute, Daejeon (KR)

(72) Inventors: Yongjun LIM, Daejeon (KR); Kwan Jung OH, Daejeon (KR)

(73) Assignee: Electronics and Telecommunications Research Institute, Daejeon (KR)

(21) Appl. No.: 19/384,365

(22) Filed: Nov. 10, 2025

(30) Foreign Application Priority Data
Nov. 11, 2024 (KR) 10-2024-0159563
Nov. 6, 2025 (KR) 10-2025-0166644

(51) Int. Cl. G01B 9/02; G01B 9/02001; G01B 9/021

(52) U.S. Cl. CPC G01B 9/02047; G01B 9/02007; G01B 9/021

(57) ABSTRACT

A transmissive digital holographic metrology apparatus, the apparatus comprises: a light source unit that emits light; a beam splitter that divides the light emitted from the light source unit; a reference arm that forms a reference beam from the divided light; an object arm that forms an object beam passing through an object from the divided light; an interference unit that interferes the object beam with the reference beam with each other to generate an interference result; and an image sensor that records the interference result as a two-dimensional image to acquire one or more interference patterns.

### CROSS-REFERENCE TO RELATED APPLICATIONS

This application claims the benefit of earlier filing date and right of priority to Korean Application No. 10-2024-0159563, filed on Nov. 11, 2024, Korean Application No. 10-2025-0166644, filed on Nov. 6, 2025, the contents of which are all hereby incorporated by reference herein in their entirety.

### TECHNICAL FIELD

The present disclosure relates to an all-optical spatial frequency domain scanning method and apparatus for increasing resolution without reducing a measurement region in a phase-detection-based measurement structure. More specifically, the present disclosure relates to an all-optical spatial frequency domain scanning method and apparatus that performs a synthetic aperture scheme without mechanical movement in the phase-detection-based measurement structure. The present disclosure may be applied to the implementation of industrial optical measurement equipment in fields such as semiconductors and displays. In addition, the phase-detection-based measurement structure may be implemented using a holographic microscope or Fourier ptychography, or the like.

### BACKGROUND

In general, a complex image for an arbitrary object may be obtained by acquiring the amplitude or intensity information and the phase information of light as follows. Through a camera or a general image sensor, image acquisition based on intensity images is common.

Using phase information, it is possible to measure characteristics such as the refractive index distribution inside biological cells or the surface structure of an object or a metal surface through reflection measurements.

However, to acquire a phase image, a camera capable of operating at a speed corresponding to the vibration frequency of light is required. Since the frame rate, which represents the operation or response speed of an image sensor, cannot practically reach the order of gigahertz (GHz) per second, such high-speed operation is virtually impossible. Accordingly, in general, phase information of an object is acquired through an interferometer structure that generates interference phenomena.

### SUMMARY

The object of the present disclosure is to provide an all-optical scanning method and apparatus using a spatial light modulator (SLM), a microlens array, and/or a condenser lens in a digital holographic metrology structure.

It is a further object of the present disclosure to provide an all-optical scanning method and apparatus using a high-speed digital micromirror device (DMD)-based spatial light modulator (SLM), a microlens array, and/or a condenser lens in a digital holographic metrology structure.

It is a further object of the present disclosure to provide synthetic aperture digital hologram image acquisition method and a digital holographic metrology apparatus using the all-optical scanning method and apparatus.

It is a further object of the present disclosure to provide a reflective synthetic aperture digital hologram image acquisition method and a reflective digital holographic metrology apparatus that performs all-optical scanning outside an objective lens.

The features briefly summarized above regarding the present disclosure are merely exemplary aspects of the detailed description of the present disclosure that follows and do not limit the scope of the present disclosure.

In accordance with an aspect of the present disclosure, the above and other objects can be accomplished by the provision of a transmissive digital holographic metrology apparatus, the apparatus comprises: a light source unit that emits light; a beam splitter that divides the light emitted from the light source unit; a reference arm that forms a reference beam from the divided light; an object arm that forms an object beam passing through an object from the divided light; an interference unit that interferes the object beam with the reference beam with each other to generate an interference result; and an image sensor that records the interference result as a two-dimensional image to acquire one or more interference patterns, wherein the object arm further includes a predetermined optical scanning device, wherein the predetermined optical scanning device comprises a spatial light modulator (SLM), a microlens array, and a condenser lens, wherein a digital micromirror device (DMD) is used as the spatial light modulator, and wherein the microlens array is inserted between the DMD and the condenser lens.

In the transmissive digital holographic metrology apparatus according to the present disclosure, the light source unit includes a continuous laser.

In the transmissive digital holographic metrology apparatus according to the present disclosure, the predetermined optical scanning device further includes a 4f optical system, and the microlens array is inserted in a virtual DMD region formed by the 4f optical system and at a stop position of the condenser lens.

In the transmissive digital holographic metrology apparatus according to the present disclosure, the microlens array comprising at least one lens corresponds one-to-one to a pixel within a corresponding region of the DMD, and the sample plane of the object is irradiated through the at least one lens by switching the corresponding pixel to an ON state according to a predetermined direction.

In the transmissive digital holographic metrology apparatus according to the present disclosure, the predetermined direction is a counterclockwise direction.

In accordance with an aspect of the present disclosure, the above and other objects can be accomplished by the provision of a reflective digital holographic metrology optical apparatus, the apparatus comprises: at least one beam splitter that divides incident light into an object beam and a reference beam; at least one polarization beam splitter that polarizes at least one of the object beam or the reference beam; an object reflection unit that forms reflected light using the object beam; an interference unit that interferes the reflected light and the reference beam with each other to generate an interference result; and an image sensor that records the interference result as a two-dimensional image to acquire one or more interference patterns, wherein the incident light is generated through a predetermined optical scanning device, wherein the predetermined optical scanning device comprises a spatial light modulator (SLM), a microlens array, and a condenser lens, wherein a digital micromirror device (DMD) is used as the spatial light modulator, and wherein the microlens array is inserted between the DMD and the condenser lens.

In the reflective digital holographic metrology optical apparatus according to the present disclosure, the apparatus further comprises an objective lens that collects the reflected light and transmits it to the interference unit, wherein the predetermined optical scanning device is located outside the objective lens and is configured to irradiate a sample plane of the object.

In the reflective digital holographic metrology optical apparatus according to the present disclosure, the predetermined optical scanning device further includes a 4f optical system, and the microlens array is inserted in a virtual DMD region formed by the 4f optical system and at a stop position of the condenser lens.

In the reflective digital holographic metrology optical apparatus according to the present disclosure, the microlens array comprising at least one lens corresponds one-to-one to a pixel within a corresponding region of the DMD, and the sample plane of the object is irradiated through the at least one lens by switching the corresponding pixel to an ON state according to a predetermined direction.

In the reflective digital holographic metrology apparatus according to the present disclosure, the predetermined direction is a counterclockwise direction.

In the reflective digital holographic metrology apparatus according to the present disclosure, the image sensor includes a 4D camera, and one or more phase-shifted interference patterns are acquired through the 4D camera.

In the reflective digital holographic metrology apparatus according to the present disclosure, the 4D camera has a subpixel structure of 0°, 45°, 90°, and −45°.

In the reflective digital holographic metrology apparatus according to the present disclosure, the one or more phase-shifted interference patterns includes a first interference pattern having a phase shift of 0, a second interference pattern having a phase shift of π/2, a third interference pattern having a phase shift of π, and a fourth interference pattern having a phase shift of 3π/2.

In accordance with an aspect of the present disclosure, the above and other objects can be accomplished by the provision of a method for acquiring digital hologram image, the method comprises: emitting light from a light source; dividing the emitted light; forming a reference beam from the divided light; forming an object beam that passes through an object from the divided light; interfering the object beam and the reference beam with each other to generate an interference result; and recording the interference result as a two-dimensional image to acquire one or more interference patterns, wherein the step of forming the object beam includes performing a predetermined optical scanning, and the predetermined optical scanning is performed using a spatial light modulator (SLM), a microlens array, and a condenser lens, wherein a digital micromirror device (DMD) is used as the spatial light modulator, and wherein the microlens array is inserted between the DMD and the condenser lens.

In the method for acquiring digital hologram image according to the present disclosure, a Fourier spectrum is obtained by performing a Fourier transform on the one or more interference patterns, and a final hologram image is reconstructed by using synthetic aperture technique on the Fourier spectrum in a frequency domain, wherein the one or more interference patterns are acquired by individually switching pixels of the DMD to an ON or OFF state.

In the method for acquiring digital hologram image according to the present disclosure, a Fourier spectrum is obtained by performing a Fourier transform on the one or more interference patterns, and a final hologram image is reconstructed by performing synthetic aperture technique on the Fourier spectrum in a frequency domain, wherein coordinates on an x-axis in the frequency domain are determined based on a sine value of an incident angle and a cosine value of an azimuth angle of the light, and the sine value of the incident angle and the cosine value of the azimuth angle are defined by coordinates on a plane of the DMD and a vertical distance between the light source and the object.

In accordance with an aspect of the present disclosure, the above and other objects can be accomplished by the provision of a method for acquiring digital hologram image, the method comprises: dividing incident light into an object beam and a reference beam; polarizing at least one of the object beam and the reference beam; forming reflected light using the object beam; interfering the reflected light and the reference beam with each other to generate an interference result; and recording the interference result as a two-dimensional image to acquire one or more interference patterns, wherein the incident light is generated as a result of performing a predetermined optical scanning, wherein the predetermined optical scanning is performed using a spatial light modulator (SLM), a microlens array, and a condenser lens, wherein a digital micromirror device (DMD) is used as the spatial light modulator, and wherein the microlens array is inserted between the DMD and the condenser lens.

In the method for acquiring digital hologram image according to the present disclosure, the predetermined optical scanning is performed outside an objective lens.

In the method for acquiring digital hologram image according to the present disclosure, a Fourier spectrum is obtained by performing a Fourier transform on the one or more interference patterns, and a final hologram image is reconstructed by performing synthetic aperture technique on the Fourier spectrum in a frequency domain, wherein the one or more interference patterns are acquired by individually switching pixels of the DMD to an ON or OFF state.

In the method for acquiring digital hologram image according to the present disclosure, a Fourier spectrum is obtained by performing a Fourier transform on the one or more interference patterns, and a final hologram image is reconstructed by performing synthetic aperture technique on the Fourier spectrum in a frequency domain, wherein coordinates on an x-axis in the frequency domain are determined based on a sine value of an incident angle and a cosine value of an azimuth angle of the light, and the sine value of the incident angle and the cosine value of the azimuth angle are defined by coordinates on a plane of the DMD and a vertical distance between the light source and the object.

The technical problems to be achieved in the present disclosure are not limited to the technical problems mentioned above, and other technical problems not mentioned herein may be clearly understood by those skilled in the art from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram illustrating a structure of a transmissive digital holographic metrology optical apparatus according to an embodiment of the present disclosure.

FIG. 2 is a diagram showing a relationship between directional cosines and frequency components of irradiated incident light according to an embodiment of the present disclosure.

FIG. 3 is a diagram illustrating a procedure for synthesizing a measured hologram in a frequency domain according to an embodiment of the present disclosure.

FIG. 4 is a diagram showing an optical structure of a digital holographic microscope using synthetic aperture technique according to an embodiment of the present disclosure.

FIG. 5 is a diagram illustrating an example of light source distribution and corresponding synthesis in a frequency domain according to an embodiment of the present disclosure.

FIG. 6 is a diagram showing a structure of a transmissive digital holographic metrology optical apparatus using a DMD-based all-optical scanning device according to an embodiment of the present disclosure.

FIG. 7 is a diagram showing a structure of a DMD-based all-optical scanning device according to an embodiment of the present disclosure.

FIG. 8 is a diagram illustrating an optical simulation result of an illumination optical system using optical simulation software (ZEMAX) according to an embodiment of the present disclosure.

FIG. 9 is a diagram showing an optical structure of an illumination optical system according to an embodiment of the present disclosure.

FIG. 10 is a diagram showing a structure of a reflective digital holographic optical apparatus using a DMD-based all-optical scanning device according to an embodiment of the present disclosure.

FIG. 11 is a diagram showing a phase-shifting holographic metrology interferometer structure using a 4D camera according to an embodiment of the present disclosure.

FIG. 12 is a diagram showing an example structure of a scanning device that performs synthesis in a frequency domain according to an embodiment of the present disclosure.

FIG. 13 is a diagram illustrating a relationship between coordinates on a DMD plane and coordinates in a frequency domain according to an embodiment of the present disclosure.

FIG. 14 is a diagram showing an example of individual illuminations being turned on in the frequency domain.

FIG. 15 is a diagram illustrating an example of a lighting sequence for each circle represented in a DMD image according to the present disclosure.

FIG. 16 is a flowchart illustrating an all-optical scanning and digital hologram image acquisition method using a DMD-based all-optical scanning device according to an embodiment of the present disclosure.

FIG. 17 is a flowchart illustrating an all-optical scanning and digital hologram image acquisition method using a DMD-based all-optical scanning device according to an embodiment of the present disclosure.

### DETAILED DESCRIPTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. For example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. For example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

First, the terms used in this disclosure are briefly explained as follows.

A reference arm may refer to an optical path through which reference light, separated from a light source unit, propagates. The reference arm may be configured to control the intensity, phase, or path length of the reference light. An object arm may refer to an optical path through which light emitted from the light source unit propagates after passing through a measurement target object (object or sample). A reference beam may refer to reference light separated from the light source that travels along the reference arm without passing through the sample and is used to form an interference pattern. A reference wave may refer to a mathematical or physical representation of the wave properties of the reference beam. An object beam may refer to light separated from the light source that is formed after being transmitted through or reflected from the sample (measurement target object). An object wave may refer to a mathematical or physical representation of the wave properties of the object beam.

In general, a complex image of an arbitrary object can be obtained by acquiring amplitude or intensity information and phase information of light, as described below. The relationship among complex image information, intensity information, and phase information may be expressed by the following mathematical equation 1.

$$U ( x , y ) = A ( x , y ) exp ( j φ ( x , y ) ) \qquad [ Mathematical equation 1 ]$$

Here, U(x,y) may represent complex image information, A(x,y) may represent intensity information, j may represent an imaginary number, and φ(x,y) may represent phase information.

Through a camera or a general image sensor, image acquisition is typically based on intensity images.

Using phase information, it is possible to measure characteristics such as the refractive index distribution inside biological cells or the surface structure of an object or a metal surface through reflection measurements.

However, to acquire a phase image, a camera capable of operating at a speed corresponding to the vibration frequency of light is required. Since the frame rate, which represents the operation or response speed of an image sensor, cannot practically reach the order of gigahertz (GHz) per second, such high-speed operation is virtually impossible. Accordingly, in general, phase information of an object is acquired through an interferometer structure that generates interference phenomena.

The present disclosure aims to implement a transmissive digital holographic microscope and/or a reflective digital holographic microscope that satisfies high-resolution measurement (i.e., high-precision measurement) without loss of measurement area, which is a constraint in a digital holographic microscope structure. Alternatively, the present disclosure aims to implement a method for acquiring a synthetic aperture digital holographic image using the above microscope. The refractive index distribution may be measured using a transmissive digital holographic microscope, and the three-dimensional shape may be reconstructed using a reflective digital holographic microscope.

In a digital holographic metrology optical module, improving resolution requires increasing the numerical aperture (NA) by varying the illumination angle and synthesizing the measured holograms in a frequency domain. This can be achieved through image synthesis (or information integration) performed not in an image plane but in a spatial frequency domain or Fourier domain. Accordingly, an illumination optical module capable of irradiating a sample plane at angles much larger than the NA of an objective lens used for hologram measurement is required.

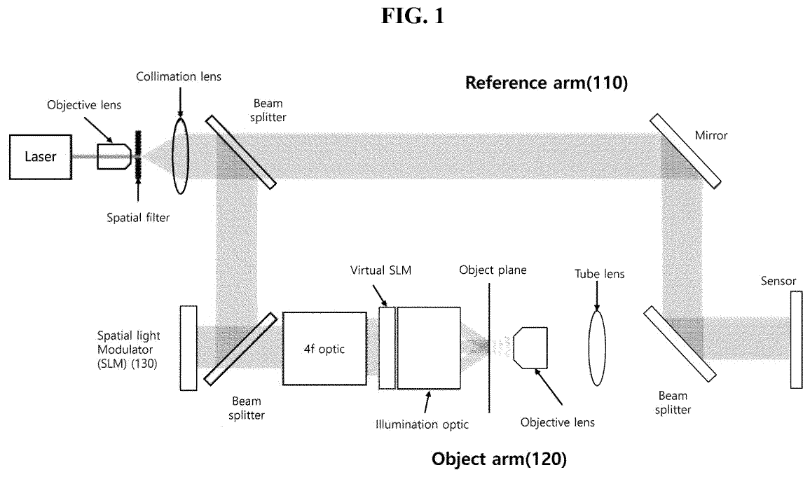

FIG. 1 is a diagram illustrating a structure of a transmissive digital holographic metrology optical apparatus according to an embodiment of the present disclosure.

Referring to FIG. 1, a transmissive digital holographic metrology optical apparatus 100 may include a light source unit, a beam splitter, a reference arm, an object arm, an interference unit, and/or an image sensor, and may further include a spatial light modulator (SLM).

Referring to FIG. 1, the light source unit may include a laser. Alternatively, the light source unit may further include a spatial filter and/or a collimation lens.

Referring to FIG. 1, the reference arm may include a path control unit (e.g., a mirror or the like) for controlling a propagation path of light.

Referring to FIG. 1, the object arm may include a 4f optical system, an illumination optical system, a measurement target object (sample), and/or an imaging optical system. The imaging optical system may be configured to include an objective lens and/or a tube lens.

A 4f optical system includes a pair of lenses, and a filter may be disposed between the lenses.

Referring to FIG. 1, the 4f optical system may perform filtering to use only the signal of the modulated illumination light.

The illumination optical system may be implemented using a condenser lens. Alternatively, it may be implemented using an objective lens having a larger NA than that of the objective lens used for hologram measurement. Alternatively, it may be implemented using a mirror-based optical system such as a galvano mirror instead of a lens.

Meanwhile, in the transmissive digital holographic metrology optical apparatus 100, the SLM may serve to modulate illumination light used to irradiate a measurement target object in a specific direction. In addition, the SLM may serve to improve resolution by imparting a specific pattern to the illumination light. The SLM may be implemented using at least one of a digital micromirror device (DMD), liquid crystal on silicon (LCoS), and liquid crystal display (LCD).

The transmissive digital holographic metrology optical apparatus 100 may synthesize measured holograms in a frequency domain while varying the illumination angle. In this case, a hologram acquired by irradiating the sample plane with illumination light having an angle larger than the NA of the objective lens may represent high-frequency components of an object beam pattern diffracted from the sample.

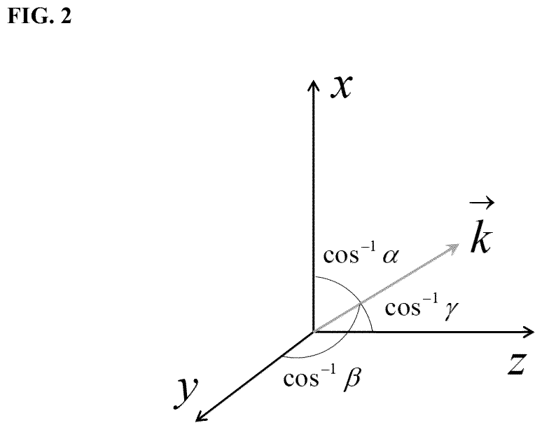

FIG. 2 is a diagram showing a relationship between directional cosines and frequency components of irradiated incident light according to an embodiment of the present disclosure.

The measured holograms may be located at different positions in the frequency domain depending on the incident angle of the illumination light. This can be explained using directional cosines.

A plane wave at a specific depth (z) may be expressed in complex form as shown in the following mathematical equation 2.

$$P ( x , y , z ) = exp [ j ( \vec{k} \cdot \vec{r} ) ] = exp [ j \frac{2 π}{λ} ( α x + β y ) ] exp [ j \frac{2 π}{λ} γ z ] \qquad [ Mathematical equation 2 ]$$

$$\vec{r} = x \hat{x} + y \hat{y} + z \hat{z} , \vec{k} = \frac{2 π}{λ} ( α \hat{x} + β \hat{y} + γ \hat{z} )$$

Here, P(x, y, z) may represent a phase of a plane wave having a wavelength λ at an arbitrary position (x, y, z) in space. A vector \vec{r} may represent a position vector in a Cartesian coordinate system, and a vector \vec{k} may represent a wavenumber vector. α, β, and γ may represent directional cosines for components along x-, y-, and z-axes, respectively.

From mathematical equation 2, a relationship between directional cosines and frequency components can be derived. The following mathematical equation 3 may represent the relationship between the directional cosines and the frequency components.

$$α = λ {f}_{x} , β = λ {f}_{y} , γ = \sqrt{1 - {( λ {f}_{x} )}^{2} - {( λ {f}_{y} )}^{2}} \qquad [ Mathematical equation 3 ]$$

Here, α, β, and γ may denote directional cosines for components along the x-, y-, and z-axes, respectively, and may correspond to the incident angles of the illumination light irradiated onto the sample.

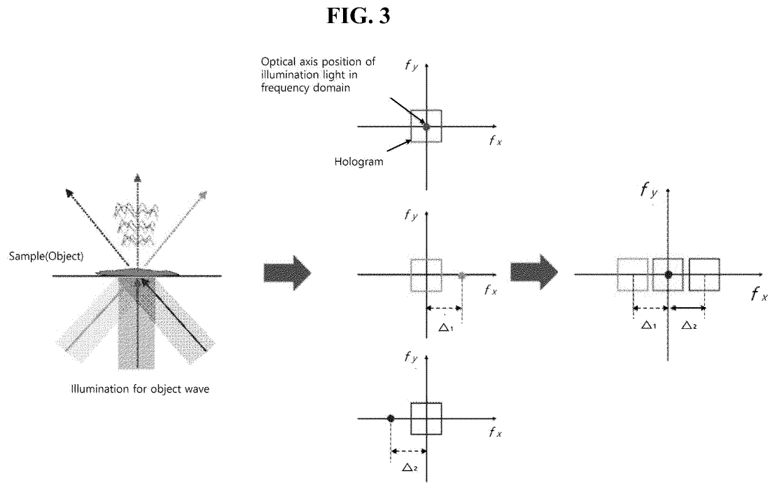

FIG. 3 is a diagram illustrating a procedure for synthesizing a measured hologram in a frequency domain according to an embodiment of the present disclosure.

Referring to FIG. 3, holograms may be measured while varying the incident angle of the illumination light, and a signal of the sample may be extracted from each hologram. In addition, the position of the illumination light and the range of the extracted signal in the frequency domain for each hologram may be determined as shown at the center of FIG. 3.

The embodiment illustrated in FIG. 3 relates to an example in which, when illumination light having a predetermined angle is irradiated onto a sample, a hologram in a high-frequency region spaced by A from the position of the incident light is measured.

By aligning the light source positions of the respective holograms in the frequency domain for the measured holograms, the holograms can be synthesized. Such a method may generally be referred to as a synthetic aperture holography technique.

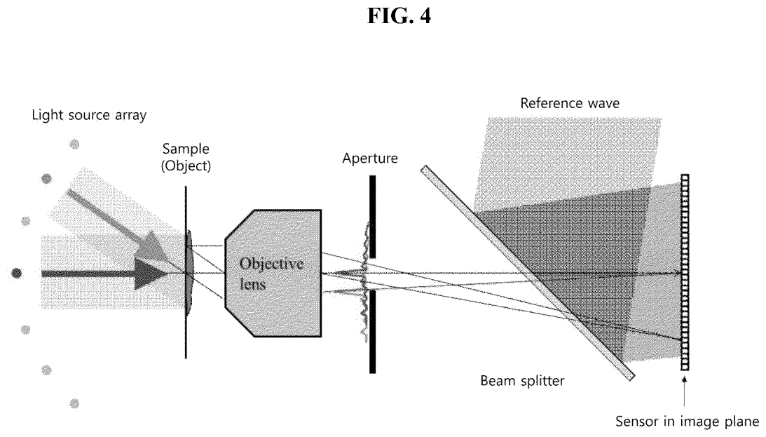

FIG. 4 is a diagram showing an optical structure of a digital holographic microscope using synthetic aperture technique according to an embodiment of the present disclosure.

According to an embodiment of the present disclosure, holograms may be synthesized using a synthetic aperture technique.

The optical apparatus 400 may include a light source array, an object (measurement target), an objective lens, an aperture, a beam splitter, a reference wave, and/or a sensor disposed on an image plane.

The light source array includes a plurality of light sources, and each light source may irradiate the measurement target object at a different incident angle. Through this configuration, it is possible to obtain a spatial frequency domain equivalent to that achieved by expanding a limited physical aperture.

Light transmitted through the measurement target object may be focused and directed to the aperture. The numerical aperture (NA) of the objective lens may serve as a key factor determining the measurement resolution.

The aperture may limit the spatial frequency components of light incident through the objective lens and allow only wave components within a specific range to pass. In the synthetic aperture technique, by combining data obtained from multiple incident angles, an effectively expanded aperture effect may be achieved.

The beam splitter may synthesize the object beam and the reference beam. The beam splitter may correspond to an interference unit that overlaps the two beams to generate an interference pattern.

The reference beam or reference wave propagates along with the reference arm and interferes with the object beam to form a digital hologram.

The image sensor is disposed on the image plane and detects the interference pattern between the object beam and the reference beam transmitted through the beam splitter. As the image sensor, a CCD or CMOS sensor may be used. The detected interference pattern may then be utilized for phase reconstruction and metrology analysis through digital computation.

In a digital holographic microscope optical structure, there is a trade-off between the measurement area and the measurement resolution. The measurement area and measurement resolution may be determined by the objective lens. When the NA of the objective lens is increased, the measurement resolution of the hologram can be improved, but the measurement area may be reduced. Conversely, when the NA of the objective lens is decreased, the measurement area of the hologram can be increased, but the measurement resolution may be degraded. Accordingly, by adding a separate device capable of controlling the direction of light incident on the sample in the object arm, it becomes possible to acquire off-axis holographic interference patterns at high angles.

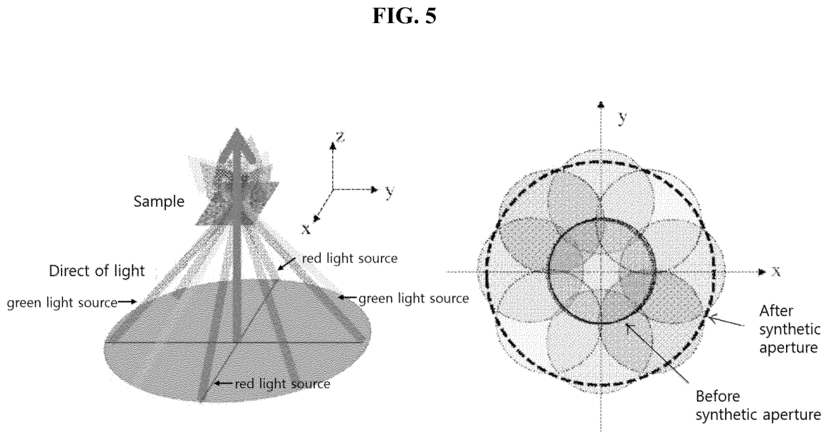

FIG. 5 is a diagram illustrating an example of light source distribution and corresponding synthesis in a frequency domain according to an embodiment of the present disclosure.

In a digital holographic microscope optical structure, an object plane (or sample plane) on which the sample is positioned may be configured to satisfy a Fraunhofer diffraction relationship. By using an additional optical system, light may be irradiated onto the sample plane at a predetermined angle according to the position of each light source. The diffracted light of the object formed on the sample plane may pass through an objective lens and an aperture or a tube lens, and then be incident on an image sensor.

On the left side of FIG. 5, a light ray distribution resulting from irradiation of light from a light source array or a light source unit onto the sample plane is illustrated. In FIG. 5, the red light source represents illumination with an incident angle of 0°, and the green light source represents illumination incident at a predetermined nonzero angle.

Referring to FIG. 5, the diffraction pattern of the object beam may be formed on the aperture plane. In this case, it may be seen that high-frequency components of the object beam are measured through the green light source.

On the right side of FIG. 5, a process of synthesizing the diffraction pattern of the object wave using a synthetic aperture method is illustrated.

The object wave formed by sequentially changing the direction of the illumination light may interfere with the reference wave to form a hologram.

Since the direction of the illumination light corresponds to a shifting relationship in the frequency domain, the pattern of the object wave for illumination at various angles may be shifted in the frequency domain according to each direction. Through Fourier transformation, the object wave can be shifted in the frequency domain according to the illumination angle, thereby gradually expanding along the x- and y-axes and filling the high-frequency components.

An inverse Fourier transform may then be performed on the signal in the frequency domain to reconstruct the sample. In this process, the high-frequency components of the signal correspond to optical waves representing finer patterns or structures, so during sample reconstruction, a complex-field data distribution with enhanced resolution may be obtained, and ultimately, a phase value may be derived.

The present disclosure aims to improve phase detection results (including phase values and phase images) in a Fourier typography microscope structure. Unlike a method of detecting image information by acquiring an image with an interference pattern from a general interferometer structure, the Fourier ptychography microscope structure may extract phase information from an intensity image that distinguishes between light and dark.

In a general microscope, resolution is generally determined by the information within the NA of the objective lens and by bright-field illumination. In contrast, a Fourier ptychographic microscope may enhance resolution by additionally employing dark-field illumination. In a general microscope, improving resolution requires using an objective lens with a high NA and high magnification, which inevitably reduces the field of view (FOV). However, in a Fourier ptychographic microscope, resolution enhancement may be achieved without reducing the FOV by applying a dark-field illumination system and modifying the bright-field illumination structure. In other words, an improvement in microscope resolution may be achieved by increasing the space-bandwidth product (SBP). In other words, an improvement in microscope resolution can be achieved by increasing the space-bandwidth product (SBP).

To employ a synthetic aperture technique, it is essential to include an optical system capable of controlling the direction of light incident on the sample. As the optical system, a light source array or a galvano scanning mirror may be used. However, a light source array is not suitable for holographic metrology, which is based on interference. In the case of a galvano scanning mirror, the mechanical structure required for x- and y-axis control, together with the associated optical configuration, increases the complexity of the optical system.

Therefore, in this disclosure, a digital holographic metrology optical system using a DMD as an SLM is proposed.

When a DMD is used, the illumination angle may be precisely and rapidly controlled on a pixel basis. However, since the illumination region on the sample depends on the diffraction angle of the DMD pixels, the field of view (FOV) of the image may be reduced.

Accordingly, the present disclosure proposes a digital holographic metrology optical system that employs a DMD-based approach using a microlens array and a condenser lens having a high numerical aperture (NA). According to the method and apparatus of the present disclosure, both a wide field of view (FOV) and high-resolution measurement can be achieved simultaneously.

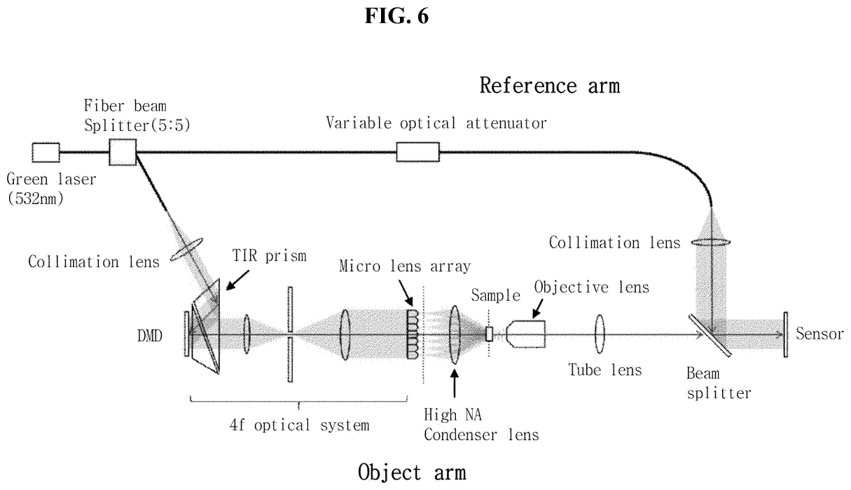

FIG. 6 is a diagram showing a structure of a transmissive digital holographic metrology optical apparatus 600 using a DMD-based all-optical scanning device according to an embodiment of the present disclosure.

The transmissive digital holographic metrology optical apparatus 600 may have a structure in which light emitted from an illumination optical system passes through a sample and subsequently passes through an objective lens and/or a tube lens to reach an image sensor.

The transmissive digital holographic metrology optical apparatus 600 may include a light source unit, a beam splitter, a reference arm, an object arm, an interference unit, and/or an image sensor. The object arm may further include a DMD serving as a spatial light modulator.

In general, a digital holographic microscope may use a laser as a light source. Referring to FIG. 6, a green laser (wavelength: 532 nm) may be used as the light source.

Referring to FIG. 6, light emitted from the light source unit may be split by a beam splitter and directed into the reference arm and the object arm, respectively. The beam splitter may be implemented using a fiber beam splitter. Here, the fiber beam splitter may refer to an optical device used to divide light from a single optical fiber into two or more optical fibers, or conversely, to combine light from multiple optical fibers into one optical fiber.

Referring to FIG. 6, the reference arm may include a variable optical attenuator (VOA) and/or a collimation lens. The brightness of the reference beam may be adjusted by passing the light through the variable optical attenuator. The reference beam passing through the VOA may be converted into a plane wave by the collimation lens. The plane wave may then pass through the interference unit and be irradiated onto the image sensor. The interference unit may be implemented by a beam splitter.

Referring to FIG. 6, the object arm may include an all-optical scanning device, a measurement target object (sample), and/or an imaging optical system. Alternatively, it may further include auxiliary optical components such as a collimation lens and/or a total internal reflection (TIR) prism. The imaging optical system may be configured to include an objective lens and/or a tube lens.

The all-optical scanning device proposed in the present disclosure may include a DMD, a microlens array, and/or a condenser lens, and may further include a 4f optical system.

Referring to FIG. 6, in the object arm, light from the light source may also be collimated through a collimation lens. The collimated light may then be irradiated onto the DMD.

Referring to FIG. 6, light modulated by the DMD may pass through the 4f optical system and then be incident on the microlens array. In this case, the two lenses of the 4f optical system may have different focal lengths to enlarge the size of a virtual DMD formed by the 4f optical system. In addition, high-order terms may be filtered out in the Fourier domain so that only a zero-order signal passes through, and the microlens array may be positioned at the location of the virtual DMD.

Referring to FIG. 6, a condenser lens having a high numerical aperture (NA) is positioned next to the microlens array, and the microlens array may be placed at a stop position of the condenser lens. The stop may refer to an aperture of the condenser lens that controls the illumination aperture. Accordingly, each lens of the microlens array may form a point light source, and light from the point light source passing through the condenser lens may be converted into a plane wave to illuminate the sample plane at a specific angle.

Referring to FIG. 6, the object wave generated after passing through the sample plane may pass through the objective lens and/or the tube lens, then pass through the interference unit, and finally be incident on the image sensor. The image sensor may acquire an interference pattern between the reference beam and the object beam.

The detected interference pattern may subsequently be reconstructed into a digital hologram through digital computation.

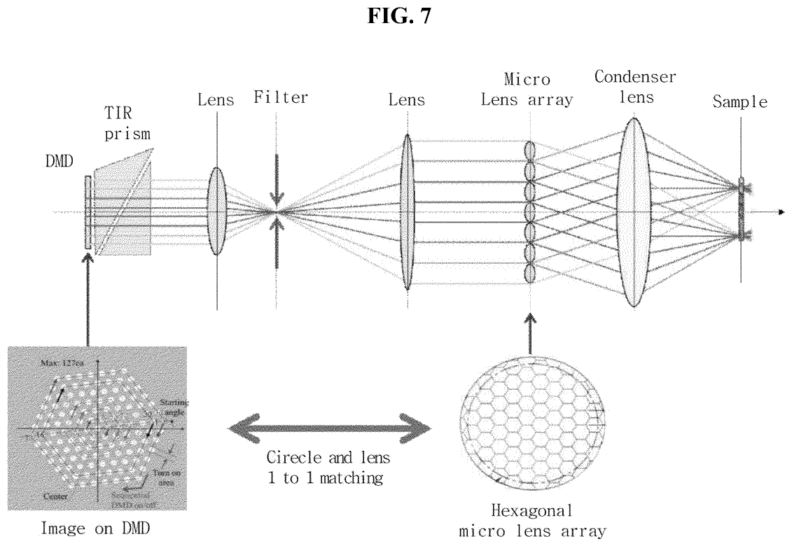

FIG. 7 is a diagram showing a structure of a DMD-based all-optical scanning device according to an embodiment of the present disclosure.

FIG. 7 illustrates in greater detail the all-optical scanning device included in the object arm of the DMD-based transmissive digital holographic metrology apparatus described with reference to FIG. 6.

Referring to FIG. 7, the all-optical scanning device may include a DMD, a microlens array, and/or a condenser lens. The microlens array may employ a hexagonal microlens arrangement.

As described with reference to FIG. 6, the collimated light from the light source may be irradiated onto the DMD.

Light modulated by the DMD may pass through a 4f optical system and then be incident on the microlens array. In this case, the two lenses of the 4f optical system may have different focal lengths to enlarge the size of the virtual DMD formed by the 4f optical system. In addition, high-order terms in the Fourier domain may be filtered out so that only the zero-order signal passes through, and the microlens array may be positioned at the location of the virtual DMD.

A condenser lens having a high NA may be positioned after the microlens array, and the microlens array may be located at a stop position of the condenser lens. Accordingly, each lens of the microlens array may form a point light source, and the light from the point light source passing through the condenser lens may be converted into a plane wave to irradiate the sample plane at a specific angle.

Meanwhile, as illustrated in FIG. 7, one or more pixels displayed on the DMD or on a DMD image may correspond one-to-one to at least one lens of the microlens array.

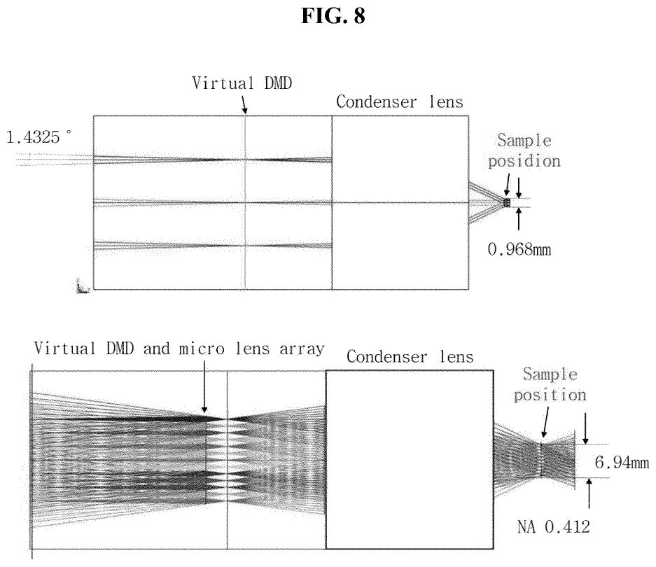

FIG. 8 is a diagram illustrating an optical simulation result of an illumination optical system using optical simulation software (ZEMAX) according to an embodiment of the present disclosure.

FIG. 8(a) illustrates an optical simulation result in the absence of a microlens array, while FIG. 8(b) illustrates an optical simulation result when a microlens array is inserted.

Referring to FIG. 8(a), the diameter of the illumination region at the sample position is 0.968 mm, indicating that the illumination area is very narrow in the absence of a microlens array. This is because a single pixel of the DMD acts as a point light source, and the diffraction angle of light diffracted from a single pixel is small. In addition, the amount of illumination light is very low, which may cause a problem.

Referring to FIG. 8(b), when a microlens array is inserted, the diameter of the illumination region increases to 6.94 mm. It can be observed that each lens of the microlens array serves as a point light source, and the light intensity from each point source is sufficiently secured. Furthermore, to reconstruct a high-resolution hologram, the illumination should provide an NA larger than that of the objective lens, and an NA of approximately 0.412—about three times higher—was achieved.

On the left side of FIG. 8, an image of the illumination light formed when a screen is placed at the sample region is shown, and on the right side of FIG. 8, an image of the illumination light formed when a screen is placed outside the sample region is shown.

Referring to FIG. 8(b), it can be observed that the illumination lights formed by each lens of the microlens array are irradiated onto the sample plane at specific angles. This demonstrates that the illumination optical system precisely controls the angle of light, indicating that the designed illumination optical system is functioning properly.

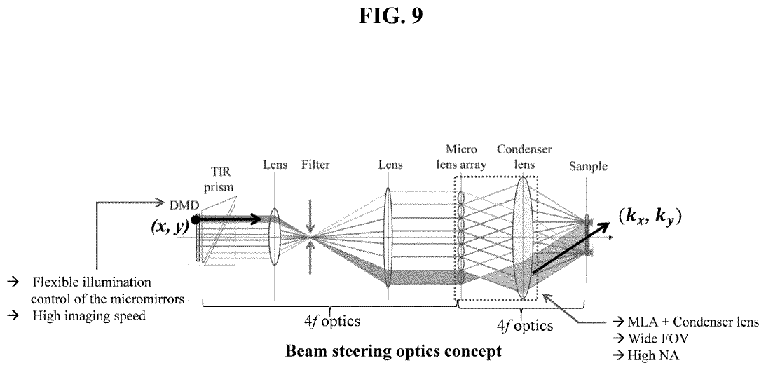

FIG. 9 is a diagram showing an optical structure of an illumination optical system according to an embodiment of the present disclosure.

The DMD-based all-optical scanning device according to an embodiment of the present disclosure may increase the NA by using a microlens array and a condenser lens, and may have a light path as illustrated in FIG. 9.

The all-optical scanning device according to an embodiment of the present disclosure may flexibly control illumination for each micromirror through the DMD and can achieve high imaging speed.

In addition, according to an embodiment of the present disclosure, the all-optical scanning device may implement a wide field of view (FOV) and a high numerical aperture (NA) through the microlens array and the condenser lens.

Furthermore, in addition to using the microlens array and condenser lens, it is also possible to enhance the NA by employing other types of array-type optical structures that perform the same function in combination with a condenser lens.

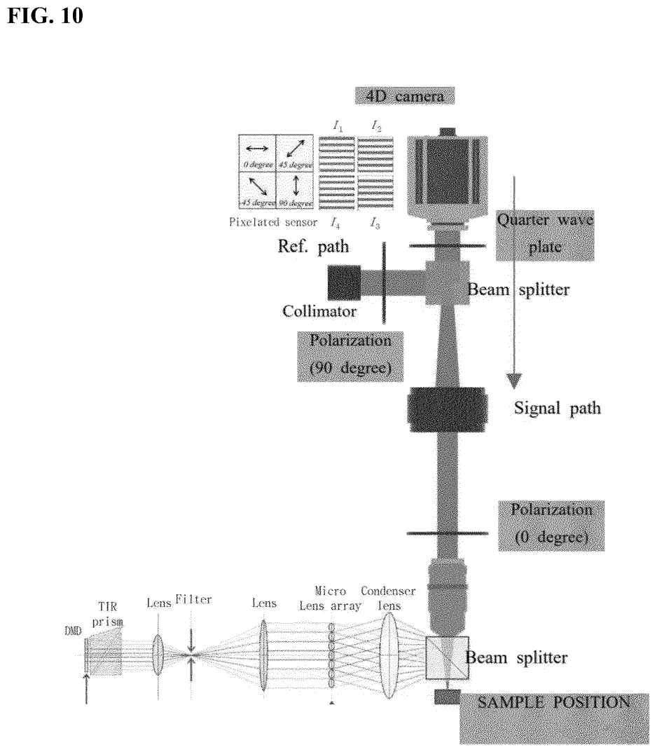

FIG. 10 is a diagram showing a structure of a reflective digital holographic optical apparatus 1000 using a DMD-based all-optical scanning device according to an embodiment of the present disclosure.

A general reflective digital holographic optical apparatus may be designed such that light is incident through the back focal plane of an objective lens.

The reflective digital holographic optical apparatus 1000 proposed in the present disclosure may be configured such that a DMD-based all-optical scanning device or the structure of the device irradiates the surface of a sample through a beam splitter located below the objective lens. Through this configuration, it is possible to overcome the cutoff frequency (which may be understood as a spatial frequency) determined by the objective lens, thereby ultimately improving resolution without loss of the measurement area (or reduction in the field of view (FOV) of the target).

Referring to FIG. 10, the reflective digital holographic metrology optical apparatus 1000 may include a beam splitter, a polarization beam splitter, an object reflection unit, an interference unit, and/or an image sensor, and may further include the all-optical scanning device proposed in the present disclosure. The DMD-based all-optical scanning device may be designed to irradiate the surface of the sample through the beam splitter positioned below the objective lens.

Referring to FIG. 10, the reflective digital holographic metrology optical apparatus 1000 may include the all-optical scanning device, and may further include an auxiliary optical system and an imaging optical system. The auxiliary optical system may include a collimation lens and/or a total internal reflection (TIR) prism, and the imaging optical system may be configured to include an objective lens and/or a tube lens.

The all-optical scanning device of the present disclosure may include a DMD, a microlens array, and/or a condenser lens. Alternatively, it may further include a 4f optical system.

Referring to FIG. 10, light incident from a light source may be irradiated onto the DMD.

Referring to FIG. 10, light modulated by the DMD may pass through a 4f optical system and then be incident on the microlens array. In this case, the two lenses of the 4f optical system may have different focal lengths to increase the size of a virtual DMD formed by the 4f optical system. In addition, high-order terms may be filtered out in the Fourier domain so that only the zero-order signal passes through, and the microlens array may be positioned at the location of the virtual DMD.

Referring to FIG. 10, a condenser lens having a high NA may be positioned after the microlens array, and the microlens array may be located at the stop position of the condenser lens. Accordingly, each lens of the microlens array may form a point light source, and light from the point source passing through the condenser lens may be converted into a plane wave to irradiate the sample surface at a specific angle.

Referring to FIG. 10, a beam splitter (for example, the first beam splitter shown in FIG. 10) may separate the incident light into two paths-a reference beam and an object beam. The beam splitter may deliver light to the sample. The light incident n the beam splitter may correspond to light transmitted along the all-optical scanning device positioned below the objective lens.

Referring to FIG. 10, a polarization beam splitter may serve to control the polarization state and to efficiently separate and combine the reference beam and the object beam. For example, the polarization beam splitter may include a 0° polarizer and/or a 90° polarizer.

Referring to FIG. 10, an object reflection unit may cause the object beam to be incident on the object (sample) and form reflected light, i.e., a reflected beam.

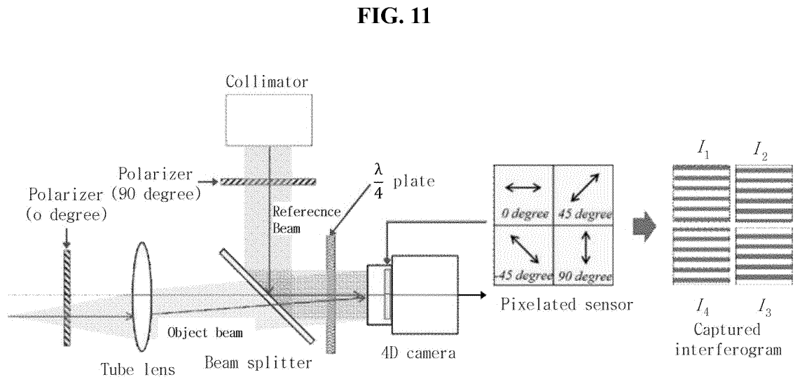

Referring to FIG. 10, an interference unit may synthesize the reference beam and the object beam. The interference unit may be implemented by a beam splitter (for example, the second beam splitter shown in FIG. 10) and a plurality of optical elements including the beam splitter. The configuration of the interference unit will be described in more detail with reference to FIG. 11.

Referring to FIG. 10, an image sensor may detect and record an interference pattern between the object beam and the reference beam passing through the interference unit. A 4D camera or the like may be used as an image sensor. The detected interference pattern may then be used for phase reconstruction and metrology analysis through digital computation.

Meanwhile, since the recorded holographic interference patterns include not only the signal of the object wave but also twin noise, it is necessary to remove only the twin noise while minimizing the loss of the signal. To effectively remove twin noise, a 4D camera and a four-step phase-shifting algorithm may be employed.

FIG. 11 is a diagram showing a phase-shifting holographic metrology interferometer structure using a 4D camera according to an embodiment of the present disclosure. The interferometer may correspond to the interference unit of the reflective digital holographic metrology optical device 1000 as discussed with reference to FIG. 10.

Referring to FIG. 10, the interference unit may include a polarization beam splitter, a collimator, a beam splitter, and/or a retarder plate. The polarization beam splitter may be configured to include a 0° polarizer and/or a 90° polarizer.

The collimator may refer to a device that converts divergent light into parallel light.

The retarder plate may refer to a phase retardation device that controls the polarization states of the reference beam and the object beam to enable or suppress interference in a desired manner.

Referring to FIG. 11, the object wave passes through the objective lens, converges and diverges, and then passes through a polarizer to become 0° polarized light, after which it passes through the tube lens and becomes collimated light. In addition, the reference wave, which is collimated by the collimator, passes through a polarizer to become 90° polarized light. The object wave and the reference wave pass through the beam splitter and then through the retarder plate, ultimately becoming left-handed and right-handed circularly polarized light, respectively. The sensor of the 4D camera may have a subpixel structure with polarization filters oriented at 0°, 45°, 90°, and −45°, arranged clockwise as illustrated. Accordingly, the two circularly polarized beams may simultaneously generate and record holographic interference patterns in which the phases are shifted by 0, π/2, π, and 3π/2, respectively, at each pixel location.

The four-step phase-shifted interference pattern images that are acquired may be computationally extracted using the following phase-shifting algorithm. The mathematical equation of the phase-shifting algorithm is given as follows.

$${A}_{0} ( \begin{matrix}cos {θ}_{0} \\ sin {θ}_{0}\end{matrix} ) = \frac{1}{2 {A}_{R}} {( \begin{matrix}cos {α}_{1} - cos {α}_{3} sin {α}_{1} - sin {α}_{3} \\ cos {α}_{2} - cos {α}_{4} cos {α}_{2} - cos {α}_{4}\end{matrix} )}^{- 1} ( \begin{matrix}{I}_{1} - {I}_{3} \\ {I}_{2} - {I}_{4}\end{matrix} ) \qquad [ Mathematical equation 4 ]$$

Here, α₁, α₂, α₃, and α₄ may represent the expected four-step phase-shift values, and I₁, I₂, I₃, and I₄ may represent the intensities of the holographic interference patterns corresponding to each phase-shift value, respectively. By substituting the four-step phase-shift values of the 4D camera and the interference patterns into the algorithm, an object wave with twin noise removed may be obtained.

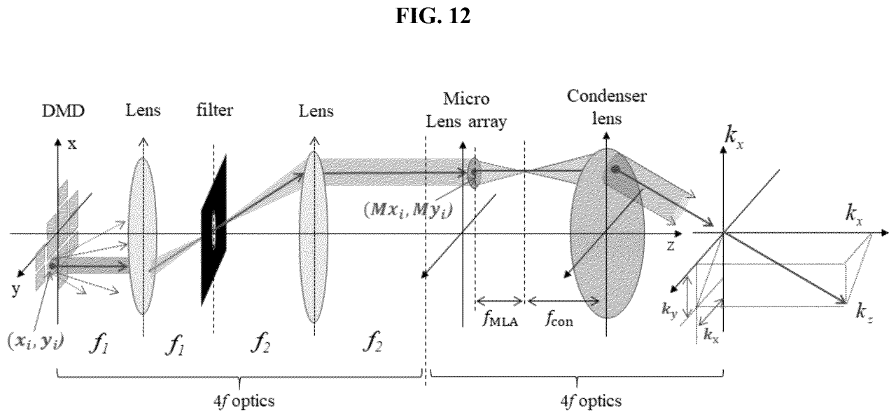

Meanwhile, FIG. 12 is a diagram showing an example structure of a scanning device that performs synthesis in a frequency domain according to an embodiment of the present disclosure.

Here, f_{MLA} may represent the focal length of the microlens array, and f_{CON} may represent the back focal length of the condenser lens. The back focal length may refer to the distance from the last refractive surface of the lens or optical system to the focal point.

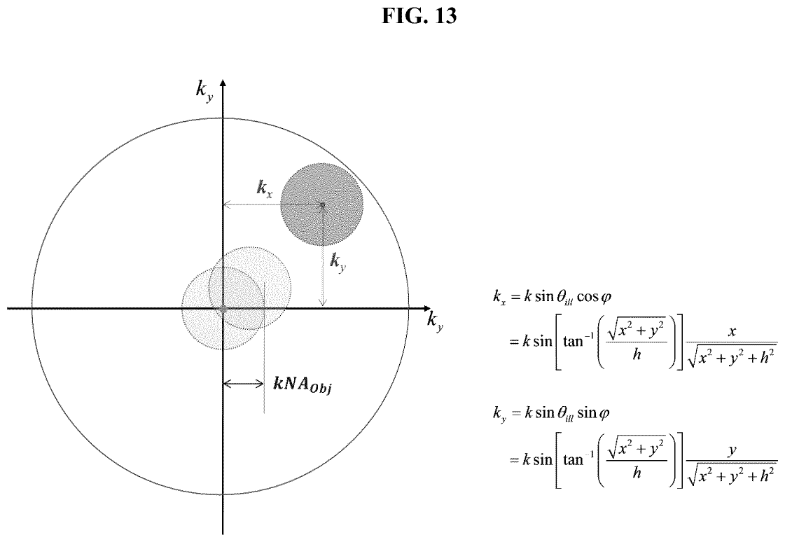

FIG. 13 is a diagram illustrating a relationship between coordinates on a DMD plane and coordinates in a frequency domain according to an embodiment of the present disclosure.

In the frequency domain, kₓ and k_{y} may be given as in the following mathematical equation 5.

$${k}_{x} = k sin {θ}_{ill} cos φ = k sin [ {tan}^{- 1} ( \frac{\sqrt{{x}^{2} + {y}^{2}}}{h} ) ] \frac{x}{\sqrt{{x}^{2} + {y}^{2} + {h}^{2}}} \qquad [ Mathematical equation 5 ]$$

$${k}_{y} = k sin {θ}_{ill} sin φ = k sin [ {tan}^{- 1} ( \frac{\sqrt{{x}^{2} + {y}^{2}}}{h} ) ] \frac{y}{\sqrt{{x}^{2} + {y}^{2} + {h}^{2}}}$$

Here, kₓ and k_{y} may represent x- and y-components of a wave vector, respectively, and may correspond to the x- and y-direction components of an incident light wave vector \vec{k}.

θᵢₗₗ may represent an incident angle, which may refer to an angle between a direction in which light from a light source is incident on an object and an optical axis.

φ may represent an azimuth angle, which may refer to an angle defining an incident direction of the light source on a DMD plane, as a rotation angle of the incident direction around a reference axis (e.g., the x-axis) on the DMD plane.

x and y may represent coordinates on the DMD plane. h may represent a height difference or a distance between the light source and the DMD plane, that is, a vertical distance from the light source to the DMD plane.

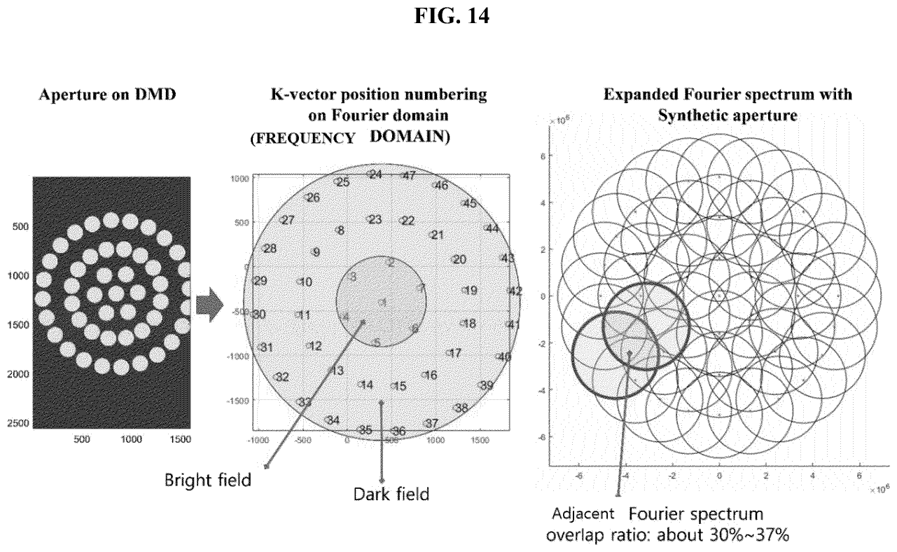

FIG. 14 is a diagram showing an example of individual illuminations being turned on in the frequency domain.

To enhance resolution in the frequency domain, different illumination conditions may be sequentially activated. In this case, each illumination condition may be represented by the position of a yellow circle displayed on the DMD image, and by turning it on or off, the direction or region of illumination can be controlled. The spectrum acquired from the object under each illumination condition includes different spatial frequency components, and each illumination condition may correspond to a specific portion of the frequency domain. Multiple frequency-domain datasets may be stitched together in the spatial frequency domain to reconstruct a final frequency spectrum. As a result, high-frequency information that cannot be obtained with a single illumination can be included, thereby increasing the overall resolution.

The size (S) of the region on the sample surface that is measured when a region (or pixel) corresponding to one yellow circle on the DMD is turned on or off may ultimately be expressed by the following mathematical equation.

$$S = \frac{2 {rf}_{2}}{{f}_{1}} \frac{{f}_{CON}}{{f}_{MLA}} \qquad [ Mathematical equation 6 ]$$

Here, S may represent the size of the measured sample. f_{MLA} may denote the focal length of the microlens array, and f_{CON} may denote the back focal length of the condenser lens. The back focal length may refer to the distance from the last refractive surface of the lens or optical system to the focal point.

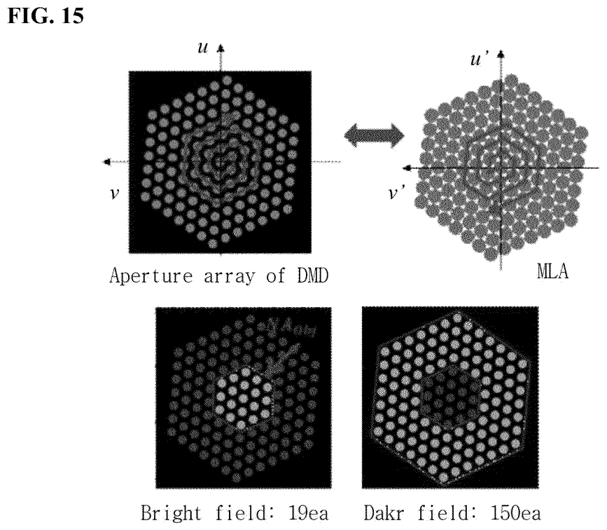

FIG. 15 is a diagram illustrating an example of a lighting sequence for each circle represented in a DMD image according to the present disclosure.

Referring to FIG. 15, pixels displayed on the DMD or on a DMD image may be controlled to turn on or off one by one along a predetermined direction. For example, the pixels may be sequentially turned on and off in a counterclockwise direction. By sequentially illuminating the pixels displayed on the DMD image one by one, the surface of the object may be irradiated.

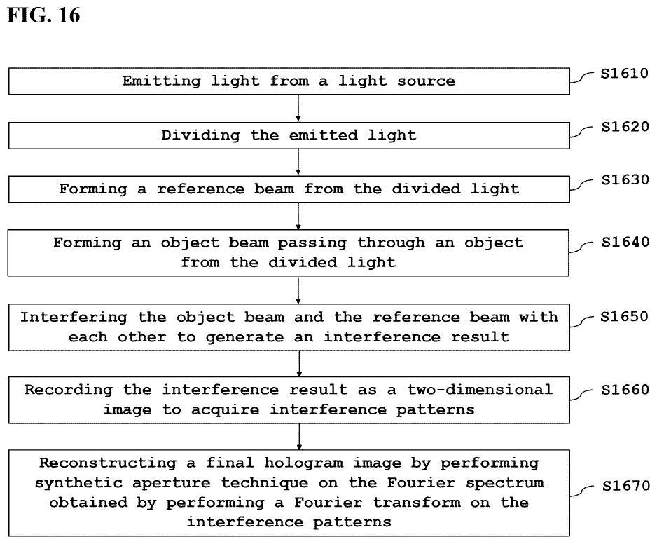

FIG. 16 is a flowchart illustrating an all-optical scanning and digital hologram image acquisition method using a DMD-based all-optical scanning device according to an embodiment of the present disclosure.

Referring to FIG. 16, light may be emitted from a light source S1610. This operation may be performed by the light source unit of the transmissive digital holographic metrology optical apparatus 600 described with reference to FIG. 6.

In general, a digital holographic microscope may use a laser as the light source. For example, a green laser (wavelength: 532 nm) may be used as the light source.

Referring to FIG. 16, the emitted light may be divided S1620. This operation may be performed by the beam splitter of the transmissive digital holographic metrology optical apparatus 600 described with reference to FIG. 6.

Light emitted from the light source unit may be divided by the beam splitter and directed into the reference arm and the object arm, respectively. The beam splitter may be implemented using a fiber beam splitter. Here, the fiber beam splitter may refer to an optical device used to divide light from a single optical fiber into two or more optical fibers, or conversely, to combine light from multiple optical fibers into one optical fiber.

Referring to FIG. 16, a reference beam may be formed from the divided light S1630. This operation may be performed by the reference arm of the transmissive digital holographic metrology optical apparatus 600 described with reference to FIG. 6.

The reference arm may include a variable optical attenuator (VOA) and/or a collimation lens. The brightness of the reference beam may be adjusted by allowing light to pass through the variable optical attenuator. The reference beam may be converted into a plane wave by the collimation lens and may pass through the interference unit to be irradiated onto the image sensor.

Referring to FIG. 16, an object beam passing through an object may be formed from the divided light S1640. This operation may be performed by the object arm of the transmissive digital holographic metrology optical apparatus 600 described with reference to FIG. 6.

The object arm may include an all-optical scanning device, a measurement target object (sample), and/or an imaging optical system. Alternatively, it may further include auxiliary optical components such as a collimation lens and/or a total internal reflection (TIR) prism. The imaging optical system may be configured to include an objective lens and/or a tube lens.

The all-optical scanning device of the present disclosure may include a DMD, a microlens array, and/or a condenser lens, and may further include a 4f optical system. The operation of the all-optical scanning device has been described with reference to FIG. 6, and therefore, a detailed explanation will be omitted here to avoid redundancy.

Referring to FIG. 16, the object beam and the reference beam may be interfered with each other to generate an interference result S1650. This operation may be performed by the interference unit of the transmissive digital holographic metrology optical apparatus 600 described with reference to FIG. 6.

As described above, the reference beam passing through the VOA may be converted into a plane wave by the collimation lens and may be directed to the image sensor through the interference unit. The interference unit may generate an interference result by interfering the object beam and reference beam. The interference unit may be implemented by a beam splitter.

Referring to FIG. 16, the interference result may be recorded as a two-dimensional image to acquire one or more interference patterns S1660. This operation may be performed by the image sensor of the transmissive digital holographic metrology optical apparatus 600 described with reference to FIG. 6.

The object wave generated after passing through the sample plane may pass through the objective lens and/or the tube lens, then pass through the interference unit, and be irradiated onto the image sensor. The image sensor may acquire an interference pattern between the reference beam and the object beam.

Referring to FIG. 16, a final hologram image may be reconstructed by performing synthetic aperture technique on the Fourier spectrum obtained by performing a Fourier transform on the one or more interference patterns S1670.

The detected interference pattern may subsequently be reconstructed into a digital hologram through digital computation. This process can be understood with reference to FIGS. 3, 5, and 14.

Specifically, interference patterns between the object beam and the reference beam, which are formed while varying the illumination angle, may be individually measured. The measured holograms may then be Fourier-transformed to separate the signal and its conjugate, and the digital hologram may be reconstructed by synthesizing the separated components in the Fourier domain.

Meanwhile, the relationship between the coordinate positions in the DMD plane and the coordinates in the frequency domain has already been described with reference to FIG. 13, and thus detailed explanation thereof is omitted here.

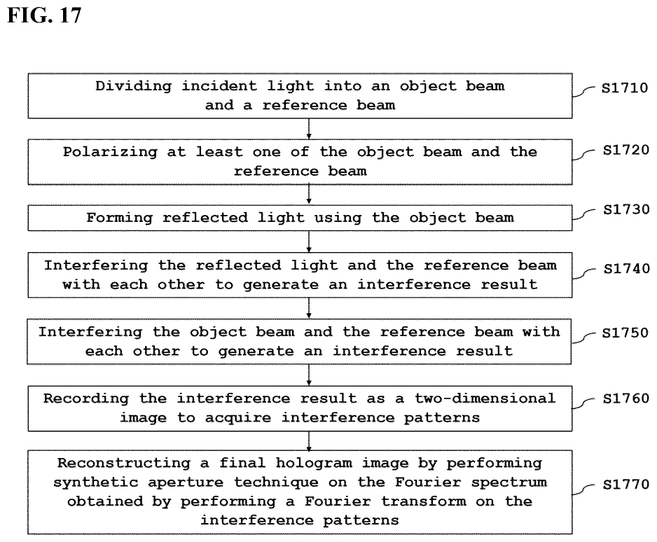

FIG. 17 is a flowchart illustrating an all-optical scanning and digital hologram image acquisition method using a DMD-based all-optical scanning device according to an embodiment of the present disclosure.

Referring to FIG. 17, incident light may be divided into an object beam and a reference beam S1710. This operation may be performed by a beam splitter (for example, the first beam splitter shown in FIG. 10) of the reflective digital holographic metrology optical apparatus 1000 described with reference to FIG. 10.

The beam splitter may separate the incident light into two paths-a reference beam and an object beam. The beam splitter may deliver light to the sample. The light incident on the beam splitter may correspond to light transmitted through the all-optical scanning device positioned below the objective lens.

A general reflective digital holographic optical apparatus may be designed such that light is incident through the back focal plane of the objective lens.

The reflective digital holographic optical apparatus proposed in the present disclosure may be configured such that a DMD-based all-optical scanning device or the structure of the device irradiates the surface of a sample through a beam splitter located below the objective lens. Through this configuration, it is possible to overcome the cutoff frequency (which may be understood as a spatial frequency) determined by the objective lens, thereby ultimately improving resolution without loss of the measurement area (or reduction in the field of view (FOV) of the target).

The all-optical scanning device of the present disclosure may include a DMD, a microlens array, and a condenser lens, and may further include a 4f optical system. The operation of the all-optical scanning device has been described with reference to FIG. 10, and therefore, a detailed explanation will be omitted here to avoid redundancy.

Referring to FIG. 17, at least one of the object beam and the reference beam may be polarized S1720. This operation may be performed by the polarization beam splitter of the reflective digital holographic metrology optical apparatus 1000 described with reference to FIG. 10.

The polarization beam splitter may serve to control the polarization state and to efficiently separate and combine the reference beam and the object beam. For example, the polarization beam splitter may include a 0° polarizer and/or a 90° polarizer.

Referring to FIG. 17, the object beam may be formed using the reflected light S1730. This operation may be performed by the object reflection unit of the reflective digital holographic metrology optical apparatus 1000 described with reference to FIG. 10.

The object reflection unit may cause the object beam to be incident on the object (sample) and form reflected light, i.e., a reflected beam.

Referring to FIG. 17, the reflected light and the reference beam may be interfered with each other to generate an interference result S1740. This operation may be performed by the interference unit of the reflective digital holographic metrology optical apparatus 1000 described with reference to FIG. 10.

The interference unit may synthesize the reference beam and the object beam and may be implemented by a beam splitter (for example, the second beam splitter shown in FIG. 10) and a plurality of optical components including the beam splitter. The interference unit may be configured as illustrated, for example, in FIG. 11.

Referring to FIG. 17, the interference result may be recorded as a two-dimensional image to acquire one or more interference patterns S1750. This operation may be performed by the image sensor of the reflective digital holographic metrology optical apparatus 600 described with reference to FIG. 10.

The object wave generated after passing through the sample plane may pass through the objective lens and/or the tube lens, then pass through the interference unit, and be irradiated onto the image sensor. The image sensor may acquire an interference pattern between the reference beam and the object beam.

Referring to FIG. 17, a final hologram image may be reconstructed by performing synthetic aperture technique on the Fourier spectrum obtained by performing a Fourier transform on the one or more interference patterns S1760.

The detected interference pattern may subsequently be reconstructed into a digital hologram through digital computation. This process can be understood with reference to FIGS. 3, 5, and 14.

Specifically, interference patterns between the object beam and the reference beam, which are formed while varying the illumination angle, may be individually measured. The measured holograms may then be Fourier-transformed to separate the signal and its conjugate, and the digital hologram may be reconstructed by synthesizing the separated components in the Fourier domain.

Meanwhile, the relationship between the coordinate positions in the DMD plane and the coordinates in the frequency domain has already been described with reference to FIG. 13, and thus detailed explanation thereof is omitted here.

According to the method and apparatus of the present disclosure, an all-optical scanning device and its structure can be implemented using a high-speed DMD, without requiring a pulsed laser light source or a heterodyne configuration that is generally necessary during scanning.

According to the method and apparatus of the present disclosure, a reflective synthetic aperture digital hologram image acquisition device and structure can be realized, which can overcome the cutoff frequency limitation of the illumination light source caused by the optical system, particularly the objective lens.

According to the method and apparatus of the present disclosure, in a general reflective scanning structure, mechanical movements such as moving the camera or the sample plane are required to obtain a defocused image. However, in the present disclosure, a defocused image can be obtained optically by using an SLM to change the imaging plane, thereby eliminating the need for mechanical movement along the optical axis.

According to the method and apparatus of the present disclosure, a high-resolution phase image may be obtained by performing a general digital hologram image reconstruction process from the hologram image.

Meanwhile, in both reflective and transmissive digital holographic microscopes, the light source may be replaced with an LED instead of a laser, the optical components in the reference path may be removed, and the 4D camera may be replaced with a general image sensor (e.g., CMOS or CCD camera) to operate the system as a Fourier ptychographic microscope.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof.

At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A transmissive digital holographic metrology apparatus, the apparatus comprising:
a light source unit that emits light;
a beam splitter that divides the light emitted from the light source unit;
a reference arm that forms a reference beam from the divided light;
an object arm that forms an object beam passing through an object from the divided light;
an interference unit that interferes the object beam with the reference beam with each other to generate an interference result; and
an image sensor that records the interference result as a two-dimensional image to acquire one or more interference patterns,
wherein the object arm further includes a predetermined optical scanning device,
wherein the predetermined optical scanning device comprises a spatial light modulator (SLM), a microlens array, and a condenser lens,
wherein a digital micromirror device (DMD) is used as the spatial light modulator, and
wherein the microlens array is inserted between the DMD and the condenser lens.

2. The apparatus of claim 1, wherein the light source unit includes a continuous laser.

3. The apparatus of claim 1, wherein the predetermined optical scanning device further includes a 4f optical system, and
wherein the microlens array is inserted in a virtual DMD region formed by the 4f optical system and at a stop position of the condenser lens.

4. The apparatus of claim 1, wherein the microlens array comprising at least one lens corresponds one-to-one to a pixel within a corresponding region of the DMD, and
wherein the sample plane of the object is irradiated through the at least one lens by switching the corresponding pixel to an ON state according to a predetermined direction.

5. The apparatus of claim 4, wherein the predetermined direction is a counterclockwise direction.

6. A reflective digital holographic metrology optical apparatus, the apparatus comprising:
at least one beam splitter that divides incident light into an object beam and a reference beam;
at least one polarization beam splitter that polarizes at least one of the object beam or the reference beam;
an object reflection unit that forms reflected light using the object beam;
an interference unit that interferes the reflected light and the reference beam with each other to generate an interference result; and
an image sensor that records the interference result as a two-dimensional image to acquire one or more interference patterns,
wherein the incident light is generated through a predetermined optical scanning device,
wherein the predetermined optical scanning device comprises a spatial light modulator (SLM), a microlens array, and a condenser lens,
wherein a digital micromirror device (DMD) is used as the spatial light modulator, and
wherein the microlens array is inserted between the DMD and the condenser lens.

7. The apparatus of claim 6, wherein the apparatus further comprises an objective lens that collects the reflected light and transmits it to the interference unit, and
wherein the predetermined optical scanning device is located outside the objective lens and is configured to irradiate a sample plane of the object.

8. The apparatus of claim 6, wherein the predetermined optical scanning device further includes a 4f optical system, and
wherein the microlens array is inserted in a virtual DMD region formed by the 4f optical system and at a stop position of the condenser lens.

9. The apparatus of claim 6, wherein the microlens array comprising at least one lens corresponds one-to-one to a pixel within a corresponding region of the DMD, and
wherein the sample plane of the object is irradiated through the at least one lens by switching the corresponding pixel to an ON state according to a predetermined direction.

10. The apparatus of claim 9, wherein the predetermined direction is a counterclockwise direction.

11. The apparatus of claim 6, wherein the image sensor includes a 4D camera, and
wherein one or more phase-shifted interference patterns are acquired through the 4D camera.

12. The apparatus of claim 11, wherein the 4D camera has a subpixel structure of 0°, 45°, 90°, and −45°.

13. The apparatus of claim 11, wherein the one or more phase-shifted interference patterns includes a first interference pattern having a phase shift of 0, a second interference pattern having a phase shift of π/2, a third interference pattern having a phase shift of π, and a fourth interference pattern having a phase shift of 3π/2.

14. A method for acquiring digital hologram image, the method comprising:
emitting light from a light source;
dividing the emitted light;
forming a reference beam from the divided light;
forming an object beam that passes through an object from the divided light;
interfering the object beam and the reference beam with each other to generate an interference result; and
recording the interference result as a two-dimensional image to acquire one or more interference patterns,
wherein the step of forming the object beam includes performing a predetermined optical scanning,
wherein the predetermined optical scanning is performed using a spatial light modulator (SLM), a microlens array, and a condenser lens,
wherein a digital micromirror device (DMD) is used as the spatial light modulator, and
wherein the microlens array is inserted between the DMD and the condenser lens.

15. The method of claim 14, wherein a Fourier spectrum is obtained by performing a Fourier transform on the one or more interference patterns,
wherein a final hologram image is reconstructed by using synthetic aperture technique on the Fourier spectrum in a frequency domain, and
wherein the one or more interference patterns are acquired by individually switching pixels of the DMD to an ON or OFF state.

16. The method of claim 14, wherein a Fourier spectrum is obtained by performing a Fourier transform on the one or more interference patterns,
wherein a final hologram image is reconstructed by performing synthetic aperture technique on the Fourier spectrum in a frequency domain,
wherein coordinates on an x-axis in the frequency domain are determined based on a sine value of an incident angle and a cosine value of an azimuth angle of the light, and
wherein the sine value of the incident angle and the cosine value of the azimuth angle are defined by coordinates on a plane of the DMD and a vertical distance between the light source and the object.

17. A method for acquiring digital hologram image, the method comprising:
dividing incident light into an object beam and a reference beam;
polarizing at least one of the object beam and the reference beam;
forming reflected light using the object beam;
interfering the reflected light and the reference beam with each other to generate an interference result; and
recording the interference result as a two-dimensional image to acquire one or more interference patterns,
wherein the incident light is generated as a result of performing a predetermined optical scanning,
wherein the predetermined optical scanning is performed using a spatial light modulator (SLM), a microlens array, and a condenser lens,
wherein a digital micromirror device (DMD) is used as the spatial light modulator, and
wherein the microlens array is inserted between the DMD and the condenser lens.

18. The method of claim 17, wherein the predetermined optical scanning is performed outside an objective lens.

19. The method of claim 17, wherein a Fourier spectrum is obtained by performing a Fourier transform on the one or more interference patterns,
wherein a final hologram image is reconstructed by performing synthetic aperture technique on the Fourier spectrum in a frequency domain, and
wherein the one or more interference patterns are acquired by individually switching pixels of the DMD to an ON or OFF state.

20. The method of claim 17, wherein a Fourier spectrum is obtained by performing a Fourier transform on the one or more interference patterns,
wherein a final hologram image is reconstructed by performing synthetic aperture technique on the Fourier spectrum in a frequency domain,
wherein coordinates on an x-axis in the frequency domain are determined based on a sine value of an incident angle and a cosine value of an azimuth angle of the light, and
wherein the sine value of the incident angle and the cosine value of the azimuth angle are defined by coordinates on a plane of the DMD and a vertical distance between the light source and the object.
